(19) United States
(12) Patent Application Publication
(10) Pub. No.: US 2002/0117847 A1
(43) Pub. Date: Aug. 29, 2002

(54) Periodic planning method, apparatus, and system

(76) Inventors: Douglas E. Ede, Chiliwack (CA); Jan Willem Kanis, Chiliwack (CA)

Correspondence Address: TRASK BRITT, P.O. BOX 2550, SALT LAKE CITY, UT, 84110, US

(21) Appl. No.: 09/794,468

(22) Filed: Feb. 27, 2001

(51) Int. Cl. B42D 15/00

(52) U.S. Cl. 283/78

(57) ABSTRACT

A method for periodically providing information relevant to a specified period of time to individuals of a group by recording the information upon a page finder or upon an article configured to be secured to a page finder. At least some individuals of the group insert a page finder upon which the recorded information is displayed into an organizer, notebook, or planner to provide ready access to a page of the notebook, organizer, or planner. Each time the page finder is used to access a marked page, the recorded information is visibly displayed to the individual. Page finder attachments and page finders that are used in effecting the method are also disclosed, as are systems for implementing the method.

### BACKGROUND OF THE INVENTION

1. Field of the Invention

The present invention relates generally to time organization methods, apparatus, and systems and, more specifically, to methods, apparatus and systems that are used to routinely inform individuals of events that have been planned over a specified period of time. In particular, the present invention relates to methods for informing a group of individuals of particular events that will occur over a specified period of time by displaying the events upon agendas that are to be provided to individuals of the group and that are in the form of page finders or articles that are configured to be secured to page finders for use in an organizer, notebook, or planner.

2. Background of the Related Art

Conventionally, time management systems were embodied as appointment books, or detailed calendars on which an individual's appointments and other scheduled events could be recorded. Typically, the individual enters the appointments or other scheduled events into such an appointment book by hand, at a small area of one or two pages that is dedicated to a specific portion of the time period (e.g., a day of the week or the time of the day on which the event is to occur) represented on the page or pages of the appointment book.

Time management systems have long included page finders to mark and facilitate an individual's access to information contained on the one or more pages that are specific to the current day or week. Typically, a page finder is removably secured within the appropriate location of a time management system, such as an organizer, a notebook, or a planner, to provide ready access to that portion of the organizer, notebook, or planner. At the appropriate time, such as at the beginning of a new day or week, the page finder is removed from the organizer, notebook, or planner and replaced at the location thereof that corresponds to the new day or week.

Over time, time management systems have evolved from means for recording appointments and other scheduled events to systems for assisting individuals in effectively managing their time by helping individuals identify the processes by which they will achieve various goals and by aiding the individuals in managing their time in a manner that will enable them to complete the various tasks that are needed to achieve their goals. In addition, time management systems have provided a means by which individuals may create records of their various activities.

By providing additional space at the page or pages that correspond to each day or other time period of a time management system, an individual may enter additional information pertinent to the corresponding time period, such as additional information about an appointment or activity or a journal entry. Other features of time management systems are, however, typically kept at different locations of the time management organizer, notebook, or planner than the calendar portion thereof. As a result, specific information from other sections of the time management organizer, notebook, or planner is neither highly visible nor immediately accessible to an individual as the individual records, views, or evaluates events for a current period of time. Consequently, important information found elsewhere in a time management system may escape consideration by an individual while the individual uses the calendar section of the time management system to record, view, or evaluate events pertaining to a specific period of time.

U.S. Pat. Nos. 5,727,894 and 6,086,281, both of which issued to Michael Sean M. Covey, disclose a page finder that is configured to display personally recorded information to remind an individual of that personal recorded information as the individual uses the page finder to access a current time period in a time management system. That page finder, which is removably attachable to page-retaining elements of a notebook or other similar apparatus, has one or more pockets, or receptacles, that are configured to removably receive, secure, and display flat inserts upon which the personal information is recorded. Among the various types of inserts that may be secured to the page finder are elements upon which an individual's roles and their accompanying goals and activities for achieving those goals may be recorded, by writing, typing, or printing such information on the insert. Thus, every time an individual accesses a page or pages that are marked by the page finder, the “roles”, and “goals” or other information that is displayed by the page finder is made visible to the individual. The information displayed by such a page finder is, however, unique and personal to the individual who recorded the information and uses the page finder.

Apparatus for use with journals, diaries, or other organizers, notebooks, or planners, have also been developed to display to an individual certain personal events for a current period of time as the individual uses such a page finder to access a desired, marked page of an organizer, notebook, or planner. On one such apparatus, disclosed in U.S. Pat. No. 5,433,546, which issued to Samuel H. Kershaw, an individual records personal event information for a time period of one week. The apparatus is then inserted into a journal to mark the current or next page on which a journal entry is to be recorded.

The inventor is not aware of any methods, apparatus, or systems in which information of activities or events that will occur over a specified period of time is recorded, provided to individuals of a group to which the activities or other events apply, and used on a page finder by individuals of the group to access pages of organizers, notebooks, or planners.

Thus, it appears that there is a need for a method, apparatus, and system by which a number of individuals in a group may be repeatedly reminded of various events or activities that are to occur over a specified period of time.

### SUMMARY OF THE INVENTION

The present invention includes a method for providing individuals of a group with repeated access to information about activities or other events that will occur over a specified period of time. The present invention also includes apparatus and systems for effecting the method.

The method of the present invention includes recording information about activities or other events upon a plurality of page finders or other articles to be secured to page finders, which articles are also referred to herein as inserts or attachments, and distributing the page finders or other articles that include the recorded information to a plurality of individuals of a group. If the recorded information is recorded upon a page finder, at least some of the individuals of the group will removably secure their page finders to a time management organizer, notebook, or planner or to another organizer or notebook to facilitate the individual's access to one or more particular pages of the organizer, notebook, or planner. When the information is recorded upon another article, such as a customizable page finder insert or other customizable page finder attachment, at least some of the individuals of the group may secure the article to a page finder and removably secure the page finder to a time management system or any other type of organizer, notebook, planner, or the like to facilitate access to particular pages thereof. Thereafter, when these individuals gain access to the marked page or pages of the time management system or other organizer, notebook, or planner, the recorded activity or event information will be made visible to these individuals. When the time period to which the recorded activities or events has been completed, the process may be repeated and the information relevant to the completed period of time replaced with recorded information pertinent to activities or events that will occur during a subsequent period of time.

The present invention also includes page finders and other articles which are securable to page finders that have recorded thereon information about activities or events that are to be conducted during a specified period of time. In addition, systems which facilitate the methods of the present invention are within the scope of the present invention.

The inventive methods, apparatus, and systems are particularly suited for use in settings where a relatively large number of individuals will be required to participate in the recorded activities or events. As an example, the group of individuals may include students, faculty members, and other members of an academic community, such as a school.

Other features and advantages of the present invention will become apparent to those of ordinary skill in the art through consideration of the ensuing description, the accompanying drawings, and the appended claims.

### BRIEF DESCRIPTION OF THE DRAWINGS

In the drawings, which illustrate exemplary embodiments of the present invention:

FIG. 1 is a flow chart depicting a time organization method incorporating teachings of the present invention;

FIG. 2 is a front view of a perforated sheet that includes a plurality of articles to be attached to a page finder, including information recorded thereon of activities or events that will occur for a group of individuals over a specified period of time;

FIG. 3 is a back view of the perforated sheet of FIG. 2;

FIG. 4 is a front view of a perforated sheet such as that shown in FIG. 2, the sheet having recorded thereon information about various activities and events that are to occur during a specified period of time;

FIG. 5 is a top view of an exemplary page finder including information recorded thereon of activities or events that will occur for a group of individuals over a specified period of time;

FIG. 6 is a schematic representation of articles of FIG. 4 being distributed to individuals of the group in accordance with the method of FIG. 1;

FIG. 7 is a schematic representation of an individual securing the article of FIG. 4 to another exemplary page finder;

FIG. 8 is a schematic representation of an individual securing another embodiment of an article including information recorded thereon to yet another exemplary page finder; and

FIG. 9 is a schematic representation of an individual inserting the page finder of FIGS. 5, 7, or 8 secured to a page-retaining element of a spiral-bound organizer, notebook, or planner.

### DETAILED DESCRIPTION OF THE INVENTION

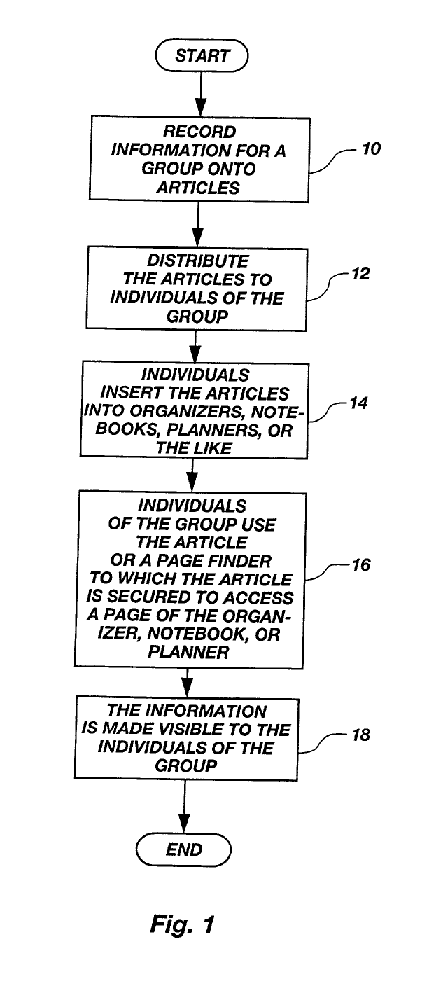

FIG. 1 is a flow chart which depicts an exemplary embodiment of a method incorporating teachings of the present invention. While the flow chart of FIG. 1 illustrates various parts of the method as being conducted in a specific order, the invention is not limited to the illustrated order of events.

As shown at reference character 10 of the flow chart of FIG. 1, the method of the present invention includes recording information about activities or other events that will occur over a specified period of time upon a plurality of page finders or articles to be secured to page finders. At reference character 12, the page finders or articles upon which the activity or event information has been recorded are distributed to a plurality of individuals of the group along with instructions to secure the page finders or other articles into an organizer, notebook, planner, or the like. At least some individuals of the group may secure page finders including the recorded information to desired locations of their organizers, notebooks, or planners, as shown at reference character 14. Once an individual has secured a page finder with recorded information of activities or other events that are pertinent to the specified period of time to an organizer, notebook, or planner, the individual may use the page finder to access a page of the organizer, notebook, or planner, at reference character 16. When an individual uses a page finder that displays the recorded information, the individual may view and be reminded of the recorded activities or other events, as shown at reference character 18.

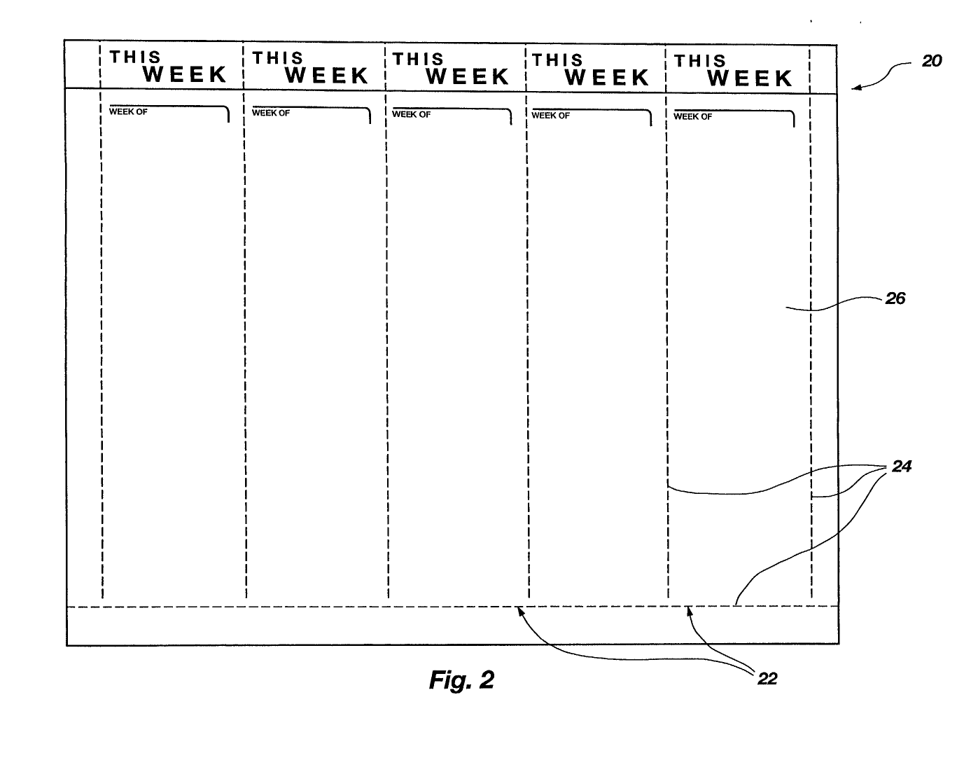

With reference to FIG. 2, a sheet 20 of paper including five preprinted articles thereon, which are also referred to herein as page finder attachments 22 or as inserts, is illustrated. As shown, sheet 20 is preperforated, with perforations 24 being located between page finder attachments 22 so as to facilitate separation of page finder attachments 22 from one another following the recordation of information thereon. Each page finder attachment 22 on sheet 20 includes a front side 26 which is configured to have recorded thereon a specified period of time, such as the beginning date of a week, as well as information about activities or other events that are scheduled to occur during that specified period of time.

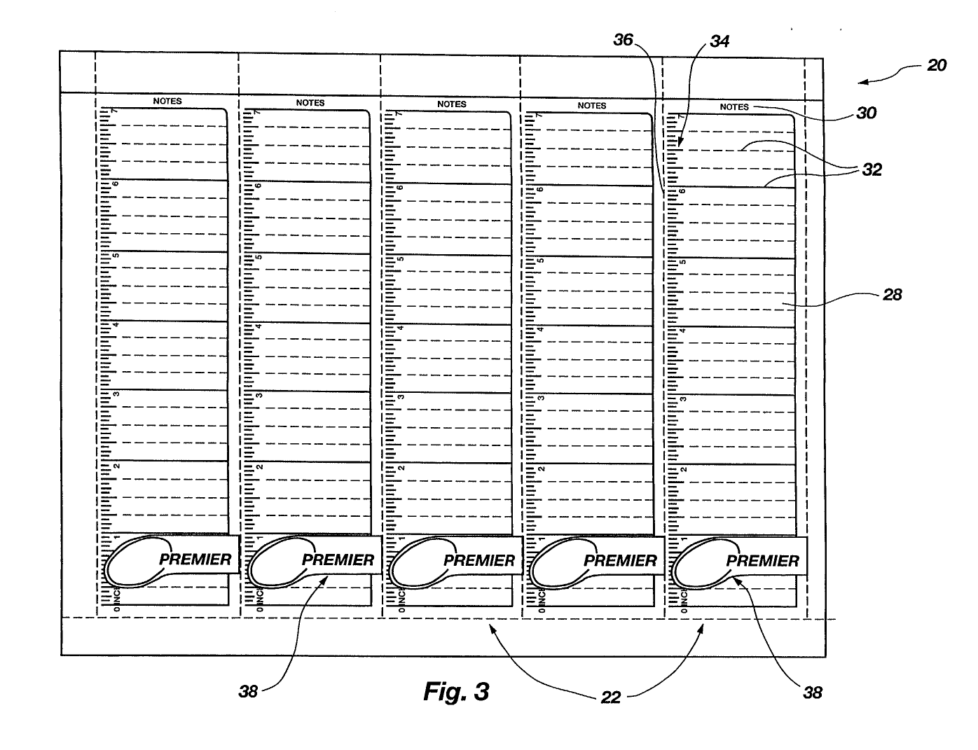

FIG. 3 depicts an exemplary back side 28 of each page finder attachment 22 on sheet 20. Back side 28 of each page finder attachment 22 includes a label 30, “NOTES”, and ruled lines 32 upon which an individual may enter notes regarding scheduled activities or other events. A ruler 34 is also printed along an edge 36 of back side 28 of each page finder attachment 22 on sheet 20. An advertisement or other indicia 38 may optionally be printed on back side 28, as shown in FIG. 3, or on front side 26 (FIG. 2) of each page finder attachment 22.

By way of example only, and not to limit the scope of the present invention, information about the activities or other events pertinent to the group of individuals during a specified period of time (e.g., a week) may be entered, using a personal computer, into an appropriate word processing program, such as WORD™ 2000, available from Microsoft Corporation of Seattle, Wash. If the information is to be recorded on sheets 20, it is preferred that the appropriate page formatting information (e.g., page and column margins) be entered into the word processing program.

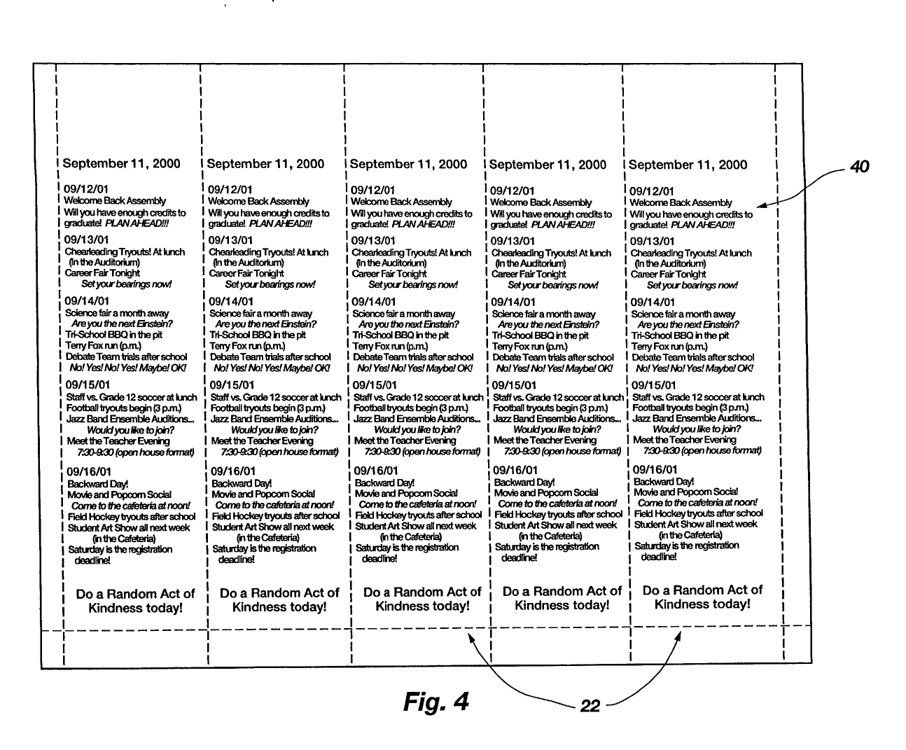

Information regarding the specified time period and the events or other activities that will occur during that specified time period are then recorded on one or more sheets 20. For example, the information may be printed directly onto front sides 26 of page finder attachments 22 on sheets 20 by use of a printer in communication with the computer that includes the word processing program into which the information was entered. As another example, the information may be printed onto a blank sheet of paper, then photocopied onto front sides 26 of page finder attachments 22 on sheets 20. In either event, identical information 40 is recorded upon a plurality of page finder attachments 22, as shown in FIG. 4.

In addition, advertisements or other indicia 38, as shown in FIG. 3, may be changed periodically, either with each new period of time, or after more than one period of time has elapsed.

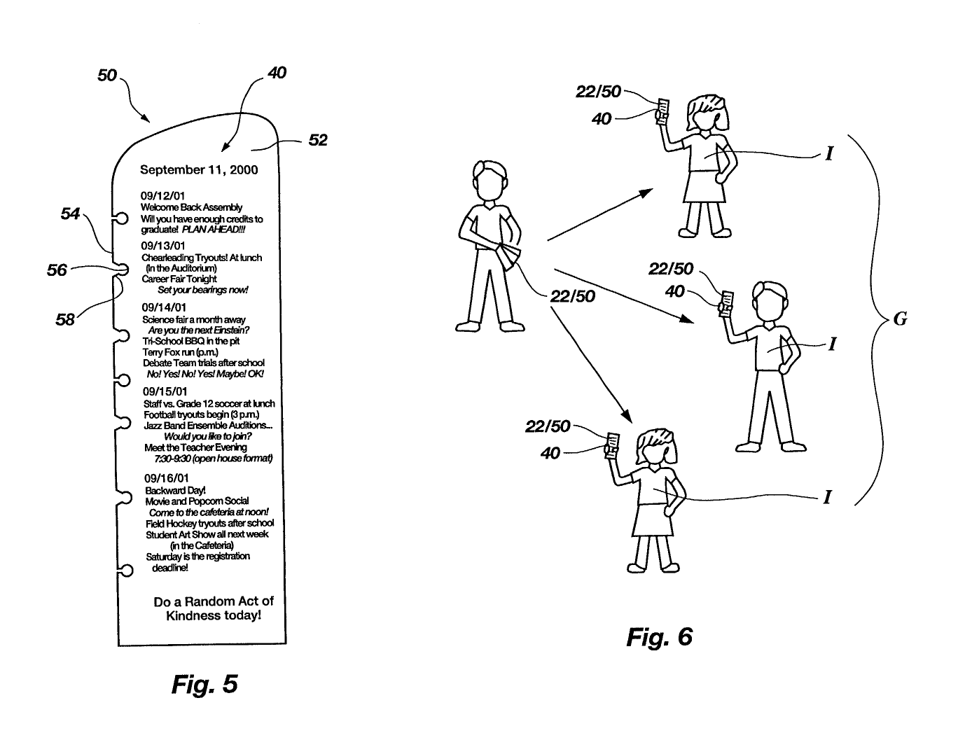

Alternatively, or in addition to recording information about activities or other events that apply to the group on sheets 20, as shown in FIG. 5, information 40 may be recorded directly, by printing or photocopying, onto the front sides 52 of a plurality of page finders 50. Each page finder 50 includes an edge 54 that is configured to be removably secured to the sheet-retaining elements (e.g., rings, posts, or other retaining elements of a loose-leaf support assembly or spiral binding of a spiral-bound notebook) of a support assembly for an organizer, planner, notebook, or the like. By way of example only, page finder 50 may include receptacles 56 that are configured to receive the sheet-retaining elements of a support assembly and that communicate with edge 54 by way of attachment notches 58, which removably retain the sheet-retaining elements within their corresponding receptacles 56.

Since page finders 50 are to be used only for the specified period of time, page finders 50 may be disposable. Accordingly, page finders 50 may be formed from an inexpensive material that will receive and retain printed or photocopied images, including, without limitation, heavyweight papers, card stocks, and any other suitable materials.

As with the page finder attachments 22 depicted in FIGS. 2 and 3, a number of page finders 50 may be formed on a sheet, which may or may not be preperforated. If the sheet is a preperforated sheet, adjacent page finders 50 may be separated from one another by way of perforations formed through the sheet. The individual page finders 50 on such a sheet may be removed from one another following the recordation (e.g., by printing or photocopying) of information about the specified time period and/or activities or other events that are scheduled to occur during the specified time period.

Referring now to FIG. 6, as well as to reference character 12 of the flow chart of FIG. 1, page finder attachments 22 (FIGS. 2 and 3) and/or page finders 50 (FIG. 5) with substantially identical information 40 recorded thereon are distributed to a plurality of individuals I of a group G. Preferably, distribution of page finder attachments 22 and/or page finders 50 is effected prior to or at the beginning of the specified period of time.

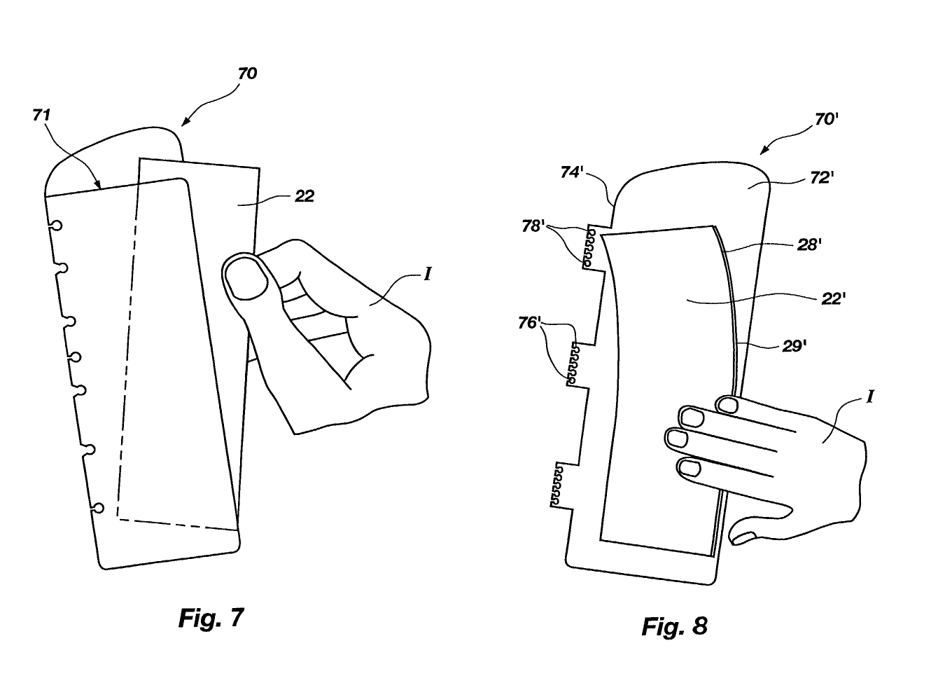

FIG. 7 depicts an individual I of group G (FIG. 6) removably securing a page finder attachment 22 of the type shown in FIGS. 2 and 3 to a page finder 70. By way of example and not to limit the scope of the present invention, individual I may insert at least portions of page finder attachment 22 into the pockets 71 of a pocketed page finder 70, such as the page finders disclosed in U.S. Design Pat. Nos. 393,483 and 404,424 and in U.S. Pat. Nos. 5,727,894 and 6,086,281, each of which issued to Michael Sean M. Covey, the disclosures of each of which are hereby incorporated in their entireties by this reference.

In an alternative example, which is depicted in FIG. 8, at least a portion of a back side 28′ of a page finder attachment 22′ may be coated with an adhesive material 29′ that will removably secure page finder attachment 22′ to a substantially flat surface 72′ of a page finder 70′. Preferably, upon removal of page finder attachment 22′ from surface 72′ of page finder 70′, adhesive material 29′ will leave substantially no residue on surface 72′. An exemplary adhesive material 29′ having this characteristic is the adhesive material disclosed in U.S. Pat. No. 3,691,140, which issued to Spencer Ferguson Silver and is assigned to manufactured by 3M of St. Paul, Minn., which adhesive material was originally used on 3M's POST-IT® adhesive note pads. The adhesive materials disclosed in U.S. Pat. Nos. 5,389,438 and 5,378,536, both of which issued to John A. Miller et al., and U.S. Pat. No. 4,684,685, which issued to Ralph J. Shuman et al., the disclosures of each of which are hereby incorporated in their entireties by this reference, may also be used as adhesive material 29′ on page finder attachments 22′.

As depicted, an edge 74′ of page finder 70′ is configured to be removably secured to the spiral page-retaining element of a conventional spiral-bound notebook. Accordingly, receptacles 76′ that are configured to receive such a spiral page-retaining element are formed through page finder 70′ proximate edge 74′ and communicate with edge 74′ by way of attachment notches 78′ that are continuous with edge 74′. Attachment notches 78′ facilitate the insertion of various regions of a spiral page-retaining element of a spiral-bound page supporting assembly, such as a spiral-bound notebook, into corresponding receptacles 78′ of page finder 70′, as well as the removal of the spiral page-retaining element from receptacles 78′, while also being configured to retain the spiral page-retaining element within receptacles 78′.

Alternatively, a page finder attachment 22′ may be secured to the surface of a conventional page finder including an edge that is configured to be removably secured to the page-retaining elements of a loose-leaf support assembly, such as a binder-type notebook.

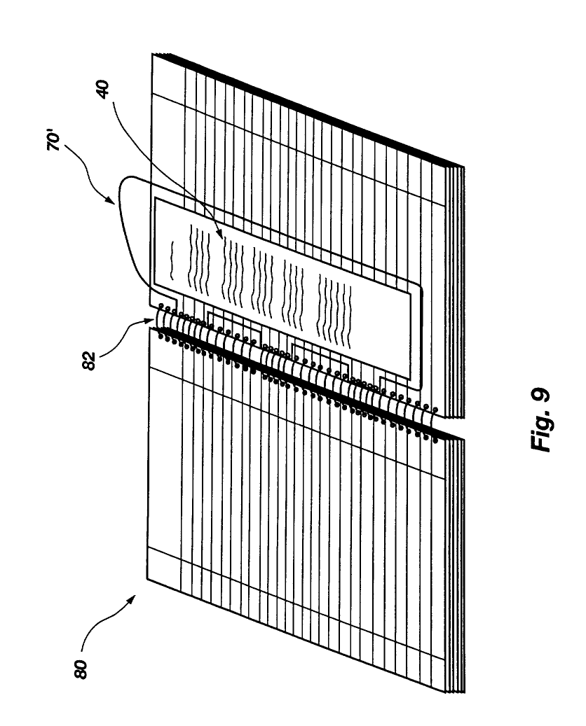

In FIG. 9, a page finder 70′ has been inserted into and secured to the spiral page-retaining element 82 of a spiral-bound notebook 80 in accordance with reference character 14 of the flow chart of FIG. 1. Alternatively, a page finder 50 (FIG. 5), 70 (FIG. 7), 70′ (FIG. 8) with information 40 thereon may be inserted into any other type of organizer, notebook, or planner and secured to a retaining element of the organizer, notebook, or planner. Page finder 70′ is preferably inserted within notebook 80 at a location to be marked and later accessed by individual I (FIG. 6).

When an individual I (FIG. 6) subsequently uses page finder 70′ to access a particular location of notebook 80, as at reference character 16 of the flow chart of FIG. 1, information 40 will be readily visible to individual I, as indicated at reference character 18 of FIG. 1, while individual I uses the marked page or pages of notebook 80.

Referring again to FIG. 6, when each of the activities or other events for the specified period have been completed, the process may be repeated by providing each individual I of group G with a page finder attachment 22, 22′ (FIG. 8) or page finder 50 including information 40 of activities or other scheduled events in which individuals of group G will or may want to be involved during a subsequent period of time.

As an example of the method of the present invention, the group may comprise a school and the individuals of that group may be the students or faculty members at the school. The recorded information may comprise an agenda of events that are scheduled to occur during the week, which each student or faculty member may choose to attend or is required to attend.

The school may be provided with sheets 20 (FIGS. 2 and 3) of page finder attachments 22, which sheets may also be referred to as a school events sheets, or with page finders 50 (FIG. 5) upon which event information may be directly recorded. As any word processing program may be configured to organize the event information in a desired format for subsequent printing or copying onto page finder attachments 22 of page finders 50, the school can print its own agendas, recording the event information upon page finder attachments 22 or page finders 50 just before the relevant period of time during which the recorded events are to occur. Consequently, the school can avoid errors on the agendas that may be associated with schedule changes that may occur between the time information is provided to an independent printing press and the time the agenda information would actually be recorded by such an independent printing press.

The weekly agenda may be provided to each student or faculty member at the school prior to or at the beginning of the pertinent week in the form of an article that can be secured to a page finder or in the form of a page finder. At least some of the students or faculty members will then secure a page finder that displays the agenda to an organizer, notebook, or planner, such as a loose-leaf support assembly (e.g., a binder) or a spiral-bound notebook, preferably at a location that will be accessed by the student or faculty member during the week. Of course, the individual may, from time to time during the week, remove the page finder one location of the organizer, notebook, or planner and replace the page finder at another location of the organizer, notebook, or planner.

Each time the page finder is used to access a marked page of the organizer, notebook, or planner, the agenda displayed thereby (i.e., directly on the page finder or on an article secured to the page finder) is made visible to the student or faculty member, providing the student or faculty member with a readily accessible reminder of the school's weekly agenda of activities or other events in which the student or faculty member may be involved.

Once all of the activities listed on the agenda have been completed, the agenda may be removed the notebook and replaced with a page finder that displays agenda information (i.e., the agenda information may be recorded directly on the page finder or on an article secured to the page finder) for the subsequent week.

Of course, teachings of the present invention are also applicable to other types of groups of individuals, for displaying information pertinent to different specified time periods, and for making other types of information readily accessible to the individuals of a group.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed is:

1. A time management method, comprising:
recording information pertinent to a specified period of time on a plurality of articles, substantially the same information appearing on each article of said plurality;
providing articles with said information recorded thereon to individuals of a group; and
instructing said plurality of individuals to removably secure said articles to notebooks, organizers, or planners, said information being made readily available to each individual of said plurality of individuals as each individual accesses a page of said organizer, notebook, or planner marked by said article.

2. The method of claim 1, wherein said recording information comprises recording an agenda of scheduled events on each article.

3. The method of claim 2, wherein said recording said agenda comprises recording an agenda of scheduled school events or activities.

4. The method of claim 1, wherein said recording information comprises recording information pertinent to said specified of time upon articles that are configured to be secured to page finders.

5. The method of claim 1, wherein said recording information comprises recording information pertinent to said specified period of time upon page finders.

6. The method of claim 1, wherein said recording information comprises recording said information on at least two locations of a sheet comprising at least two articles.

7. The method of claim 6, wherein said recording information comprises recording said information on a preperforated sheet including perforations between said at least two articles.

8. The method of claim 1, further comprising separating said articles from at least one sheet comprising a plurality of said articles.

9. The method of claim 8, wherein said separating comprises separating said articles along perforations located between adjacent articles on said at least one sheet.

10. The method of claim 1, wherein said instructing comprises instructing said plurality of individuals to removably secure a page finder displaying said information to said organizer, notebook, or planner.

11. The method of claim 10, comprising facilitating said individuals' access to a marked page of said organizer, notebook or planner with said page finder.

12. The method of claim 3, wherein said instructing comprises instructing at least one of students and faculty members at said school.

13. The method of claim 1, comprising periodically repeating said recording, providing, and instructing for information relevant to said group during subsequent periods of time.

14. A page finder system, comprising:
a page finder attachment having recorded thereon event information to be provided to a plurality of individuals of a group;
a page finder configured to receive said page finder attachment, to display said event information thereon, and to be removably secured to a page-retaining element of an agenda, notebook, or planner.

15. The page finder system of claim 14, wherein said event information comprises an agenda of activities or events scheduled for a specified period of time.

16. The page finder system of claim 14, wherein said page finder attachment comprises adhesive material on at least portions of a back side thereof for securing said page finder attachment to said page finder, said adhesive material, upon removal of said page finder attachment from said page finder, leaving substantially no residue on said page finder.

17. The page finder system of claim 14, wherein said page finder attachment is configured to be removably received within at least one pocket of said page finder.

18. The page finder system of claim 14, wherein said page finder attachment has been removed from a sheet comprising a plurality of page finder attachments with substantially identical events information recorded thereon.

19. The page finder system of claim 18, wherein said sheet comprises a preperforated sheet with perforations being located between adjacent page finder attachments.

20. The page finder system of claim 14, wherein said page finder is configured to be removably secured to a spiral page-retaining element of a spiral-bound notebook.

21. The page finder system of claim 14, wherein said group comprises a school population.

22. A page finder, comprising:
a disposable article; and
printed event information on said disposable article, said printed event information to be provided to a plurality of individuals of a group.

23. The page finder of claim 12, wherein said disposable article includes an edge configured to be removably secured to a page-retaining element of a support assembly including a plurality of pages

24. The page finder of claim 23, wherein said edge is configured to be secured to a spiral page-retaining element of a spiral-bound notebook.

25. The page finder of claim 22, wherein said printed event information comprises an agenda of events for said group over a specified period of time.

26. The page finder of claim 22, wherein said group comprises a school population.

27. The page finder of claim 22, wherein said page finder has been removed from a sheet comprising a plurality of page finders with substantially identical printed information thereon.

28. The page finder of claim 27, wherein said sheet comprises a preperforated sheet with perforations being located between adjacent page finders.
